(19) United States
(12) Patent Application Publication
(10) Pub. No.: US 2026/0122726 A1
(43) Pub. Date: Apr. 30, 2026

(54) LAND MOBILE RADIO DEVICE COMMUNICATING BASED UPON A LOCATOR ID SEPARATION PROTOCOL AND RELATED METHODS

(71) Applicant: L3HARRIS GLOBAL COMMUNICATIONS, INC., Albany, NY (US)

(72) Inventor: Matthew NOVI, Lynchburg, VA (US)

(21) Appl. No.: 18/928,121

(22) Filed: Oct. 27, 2024

(51) Int. Cl. H04W 84/04; H04L 45/745; H04W 88/06

(52) U.S. Cl. CPC H04W 84/042; H04L 45/745; H04W 88/06

(57) ABSTRACT

A land mobile radio (LMR) device may include wireless communications circuitry selectively operable over an LMR wireless communications network and a broadband (BB) wireless communications network. The LMR device may include a controller cooperating with the wireless communications circuitry to wirelessly communicate via one of the LMR wireless communications network and the BB wireless communications network based upon a Locator ID Separation Protocol (LISP).

### TECHNICAL FIELD

The present invention relates to the field of wireless communications, and, more particularly, to land mobile radio (LMR) wireless communications and related methods.

### BACKGROUND

A land mobile radio (LMR) network permits person-to-person (P2P) communication. P2P voice communication may be performed using two-way radio transceivers which can be stationary, mobile, or portable.

A broadband network broadband is a relatively high speed, wide-bandwidth data transmission network. A broadband network often operates using multiple frequencies and for accessing the Internet.

A converged radio device may wirelessly communicate over more than one network, for example, an LMR network and a broadband network each having associated coverage area. In a converged radio, internet protocol (IP) services may be accessed either through the LMR or the broadband networks. As the converged radio device moves between different coverage area, it may be desirable to provide the appropriate IP services in the corresponding coverage area.

### SUMMARY

A land mobile radio (LMR) may include wireless communications circuitry selectively operable over an LMR wireless communications network and a broadband (BB) wireless communications network. The LMR device may also include a controller cooperating with the wireless communications circuitry to wirelessly communicate via one of the LMR wireless communications network and the BB wireless communications network based upon a Locator ID Separation Protocol (LISP).

The LISP may use Endpoint Identifiers (EIDs) and Routing Locators (RLOCs) based on a Mapping Database. The controller may be configured to determine a respective communication cost associated with each of the LMR and BB wireless communications networks.

The controller may be configured to selectively switch wireless communications between the LMR and BB wireless communications networks based upon the respective communication costs, for example. The respective communications costs may be based upon respective bandwidth availabilities associated with the LMR and BB wireless communications networks, for example.

The respective communications costs may be based upon respective signal-to-noise ratios associated with the LMR and BB wireless communications networks.

The controller may be configured to operate a plurality of applications. The controller may be configured to selectively switch wireless communications between the LMR and BB wireless communications networks based upon a given one of the plurality of applications, for example.

The wireless communications circuitry may include one of WiFi communications circuitry and cellular communications circuitry operable over the BB wireless communications network. The wireless communications circuitry may include LMR circuitry operable over the LMR wireless communications network, for example.

A system aspect is directed to a communications system that may include a land mobile radio (LMR) wireless communications network, a broadband (BB) wireless communications network, and a land mobile radio (LMR) device. The LMR device may include wireless communications circuitry selectively operable over the LMR wireless communications network and the BB wireless communications network. The LMR device may also include a controller cooperating with the wireless communications circuitry to wirelessly communicate via one of the LMR wireless communications network and the BB wireless communications network based upon a Locator ID Separation Protocol (LISP).

The LISP may use Endpoint Identifiers (EIDs) and Routing Locators (RLOCs) based on a Mapping Database, for example. The controller may be configured to determine a respective communication cost associated with each of the LMR and BB wireless communications networks.

The controller may be configured to selectively switch wireless communications between the LMR and BB wireless communications networks based upon the respective communication costs. The respective communications costs may be based upon at least one of respective bandwidth availabilities associated with the LMR and BB wireless communications networks and respective signal-to-noise ratios associated with the LMR and BB wireless communications networks.

A method aspect is directed to a method of communicating using a land mobile radio (LMR). The method may include operating a controller to cooperate with wireless communications circuitry selectively operable over an LMR wireless communications network and a broadband (BB) wireless communications network to wirelessly communicate via one of the LMR wireless communications network and the BB wireless communications network based upon a Locator ID Separation Protocol (LISP).

### BRIEF DESCRIPTION OF THE DRAWINGS

FIG. 1 is a schematic diagram of a communications system according to an embodiment.

FIG. 2 is a schematic block diagram of the communications system of FIG. 1.

FIG. 3 is a schematic operational diagram of the communications system of FIG. 1.

FIG. 4 is a more detailed schematic operational diagram of the communications system of FIG. 1.

### DETAILED DESCRIPTION

1The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

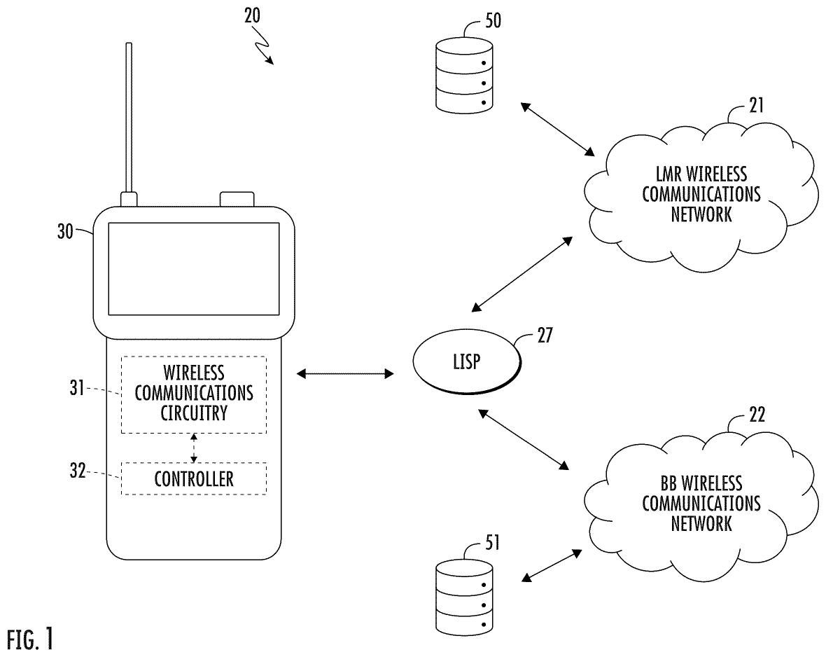

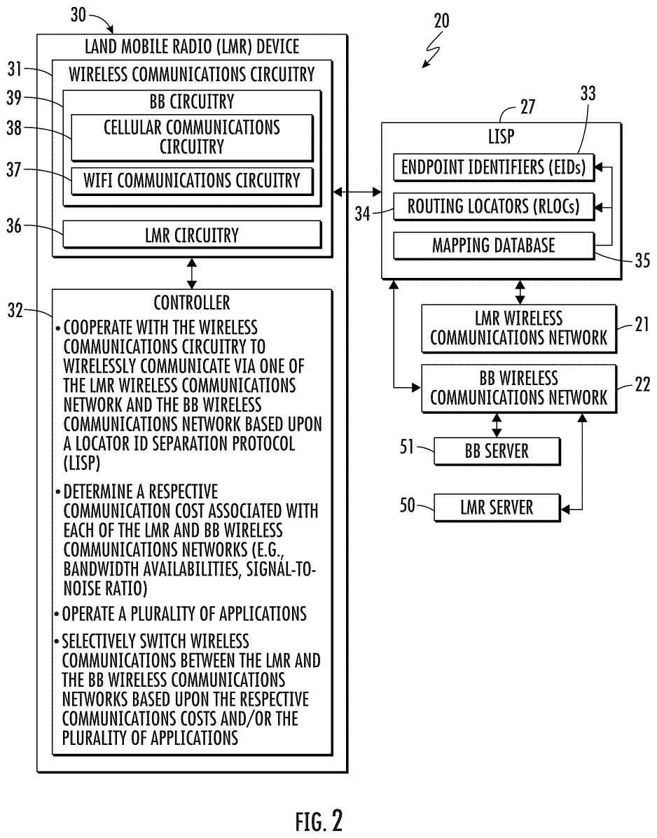

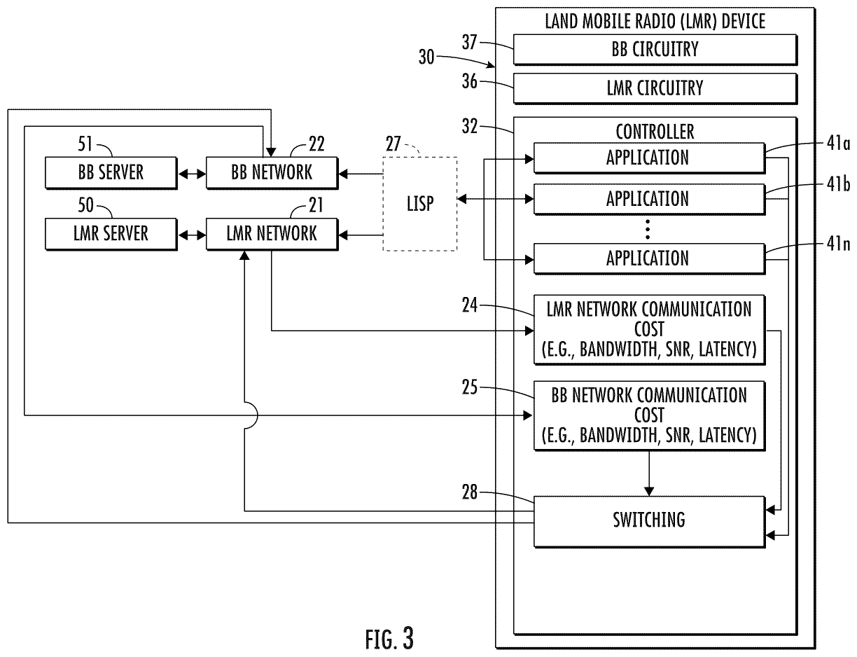

1Referring initially to FIGS. 1-3, a communications system 20 includes a land mobile radio (LMR) wireless communications network 21. The communications system 20 also includes a broadband (BB) wireless communications network 22. The BB wireless communications network 22 may include a WiFi or Ethernet wireless communications network and/or cellular wireless communications network, for example.

The communications system 20 also includes an LMR device 30. The LMR device 30 includes wireless communications circuitry 31 that is selectively operable over the LMR wireless communications network 21 and the BB wireless communications network 22. The wireless communications circuitry 31 includes LMR circuitry 36 operatable over the LMR wireless communications network 21. The wireless communications circuitry 31 also includes BB circuity 39 that may include either or both of WiFi communications circuity 37 and cellular communications circuitry 38 (e.g., long-term evolution (LTE)) operable over the BB wireless communications network 22. Accordingly, the LMR device 30 may be considered a converged radio device in that it can communicate via the LMR wireless communications network 21 and the BB wireless communications network 22.

As will be appreciated by those skilled in the art, communications over the LMR wireless communications network 21 are relatively slow, for example, 1200 baud, and the LMR wireless communications network may have a relatively low bandwidth. In contrast, communications over the BB wireless communications network 22 may be relatively fast and the BB wireless communications network may have a relatively large bandwidth.

The LMR device 30 also includes a controller 32 coupled to the wireless communications circuitry 31. The controller 32 may execute applications 41a-41n, for example, LMR communications applications, such as, mobile data terminal or network bridge applications, cryptographic key management applications, and/or location update applications. The LMR device 30 may communicate over the LMR and BB wireless communications networks 21, 22 to respective LMR and BB servers 50, 51, for example, to perform data services or functions associated with the applications 41a-41n. Some applications 41a-41n may be operable via the LMR wireless communications network 21, while others may be operable via the BB wireless communications network 22 or both the LMR and BB wireless communications networks.

The controller 32 cooperates with the wireless communications circuitry 31 to wirelessly communicate via one of the LMR wireless communications network 21 and the BB wireless communications network 22 based upon a Locator ID Separation Protocol (LISP) 27. As will be appreciated by those skilled in the art, the LISP 27 uses Endpoint Identifiers (EIDs) 33 and Routing Locators (RLOCs) 34 based upon a mapping database 35. EIDs 33 are IPv4 or IPv6 addresses that uniquely identify communication end hosts. EIDs 33 do not include inter-domain topological information. The RLOCs 34 are addresses assigned topologically to network attachment points and are typically routed inter-domain, as will be appreciated by those skilled in the art. Within the LISP 27, the EIDs 33 and the RLOCs 34 provide an architecture to build overlays on top of the underlying Internet. Mapping EIDs 33 to sets of RLOCs 34 is accomplished with the mapping database 35. By using a level of indirection for routing and addressing, separating an address identifier from its location permits scalability and mobility. By assigning EIDs 33 to mobile devices (e.g., the LMR device 30) and RLOCs 34 to the network nodes (e.g., nodes within the BB wireless communications network 22), LISP 27 can provide relatively seamless mobility.

As the LMR device 30 moves between different coverage areas of the LMR and BB wireless communications networks 21, 22, it may be desirable to provide the appropriate data services (e.g., LMR or BB) in each area. Moreover, it may be desirable for transitions between coverage areas (e.g., LMR and BB) to be transparent to the LMR and BB servers 50, 51 and that those servers need not relearn the converged client IP as it roams, as will be appreciated by those skilled in the art.

A cryptographic key management application, for example, may permit changing or rotating of cryptographic keys. The LMR server 50 may send, for example, an IP message to the LMR device 30 via the LMR wireless communications network 21 to change one of the cryptographic keys. The LMR server 50 may store a database of IP addresses each associated with an LMR device 30. If, for example, wireless communications are changed from the LMR wireless communications network 21 to the BB wireless communications network 22 (e.g., LTE) the database may be unavailable to BB server 51. Those skilled in the art will appreciate that LISP 27 addresses this shortcoming, for example, by permitting the LMR device 30 to roam with relatively transparent transitions between the networks or coverage areas. In this way, the LMR and BB servers 50, 51 may not have to relearn IP addresses and/or infrastructure as it roams.

The controller 32 advantageously permits switching 28 of wireless communications between the LMR and BB wireless communications networks, 21, 22. The controller 32 may selectively switch 28 between or wirelessly communicate with either of the LMR and BB wireless communications networks 21, 22, based upon a respective communication cost 24, 25 associated with the LMR and BB wireless communications networks. Accordingly, the controller 32 determines respective communication costs 24, 25 associated with each of the LMR and BB wireless communications networks 21, 22 and selectively switches 28 wireless communications between the LMR and BB wireless communications networks based upon the respective communication costs 24, 25.

The controller 32 may determine the respective communication costs 24, 25 based upon respective bandwidth availabilities with the LMR and BB wireless communications networks 21, 22. The controller 32 may alternatively or additionally determine the respective communication costs 24, 25 based upon respective signal-to-noise ratios and/or latency associated with the LMR and BB wireless communications networks 21, 22.

The controller 32 may also switch 28 wireless communication between the LMR and BB wireless communications networks 21, 22 based upon a given one (e.g., currently used) of the applications 41a-41n. More particularly, the controller 32 may selectively switch 28 to one of the LMR and BB wireless communications networks 21, 22 based upon the application being executed. For example, the given application may give preference to one of the LMR and BB wireless communications networks 21, 22 or operate based upon a single network (e.g., network compatibility). Accordingly, the controller 32 may switch 28 between the LMR and BB wireless communications networks 21, 22 when the cost exceeds a cost threshold and/or as desired for the given application 41a-41n, with it being desirable to offload from the LMR wireless communications network whenever possible or practical. This way, as the LMR device 30 moves between different network coverage areas, for example, handoff may be relatively transparent to both the LMR device 30 and the LMR and BB servers 50, 51 while providing corresponding communications.

In some embodiments, the controller 32 may switch among multiple networks of the same type (e.g., BB) also based upon the respective communications costs 24, 25. Of course, other and/or additional factors may serve as a basis for determining the respective communication costs 24, 25 associated with each of the LMR and BB wireless communications networks 21, 22.

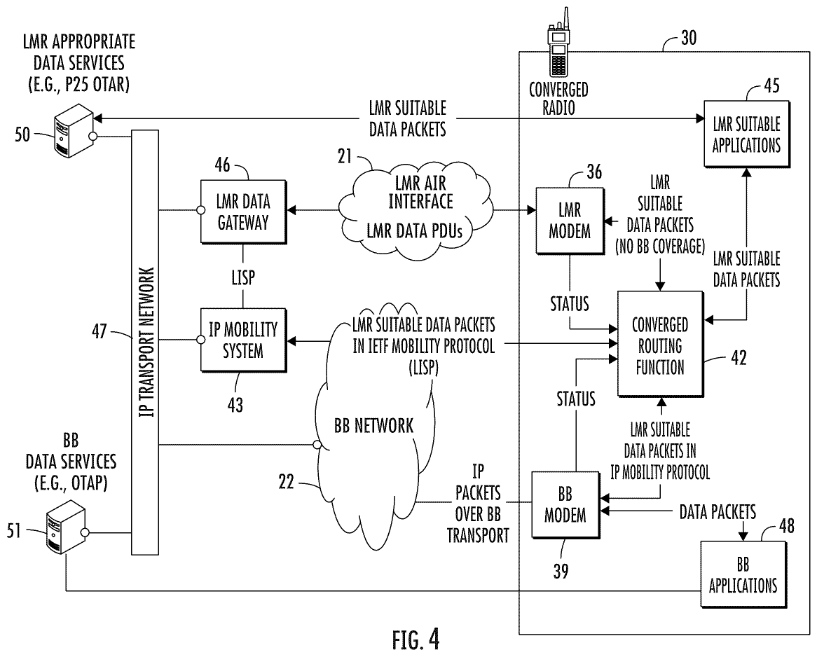

Referring now to FIG. 4, further details of a converged routing function in a converged radio, i.e., the LMR device 30 will now be described. The LMR device 30 receives status from one or more LMR modems defined by the LMR circuitry 36 and one or more BB modems defined by the BB circuitry 39. BB applications 48 communicate with the BB modem 39.

When the LMR device 30 is not in a BB communications coverage area, the LMR device, operates a converged routing function 42 to send LMR packets via LMR protocols over the LMR wireless communications network 21, for example, a best available LMR wireless communications network. When the LMR device 30 is in a BB communications coverage area, the LMR device, via the converged routing function 42 selects the BB wireless communications network 22, for example, a best available BB wireless communications network to convey LMR suitable data packets. The LMR device 30, via the converged routing function 42, establishes a relationship with an IP data mobility system 43 using an IP data mobility protocol—LISP.

Subsequently, the LMR device 30 receives packets destined for LMR suitable ones 45 of the applications 41a-41n using the IP data mobility protocol (i.e., LISP). Packets destined for the LMR suitable data services are transmitted via the IP data mobility protocol (i.e., LISP). An LMR data gateway 46 assists in routing data among the LMR wireless communications network 21, the IP mobility system 43, and an IP transport network 47. The LMR and BB servers 50, 51 provide LMR data services and BB data services respectively.

A method aspect is directed to a method of communicating using a land mobile radio (LMR) device 30. The method includes operating a controller 32 to cooperate with wireless communications circuitry 31 selectively operable over an LMR wireless communications network 21 and a broadband (BB) wireless communications network 22 to wirelessly communicate via one of the LMR wireless communications network and the BB wireless communications network based upon a Locator ID Separation Protocol (LISP) 27.

While several embodiments have been described herein, it should be appreciated by those skilled in the art that any element or elements from one or more embodiments may be used with any other element or elements from any other embodiment or embodiments. Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A land mobile radio (LMR) device comprising:
wireless communications circuitry selectively operable over an LMR wireless communications network and a broadband (BB) wireless communications network; and
a controller cooperating with the wireless communications circuitry to wirelessly communicate via one of the LMR wireless communications network and the BB wireless communications network based upon a Locator ID Separation Protocol (LISP).

2. The LMR device of claim 1 wherein the LISP uses Endpoint Identifiers (EIDs) and Routing Locators (RLOCs) based on a Mapping Database.

3. The LMR device of claim 1 wherein the controller is configured to determine a respective communication cost associated with each of the LMR and BB wireless communications networks.

4. The LMR device of claim 3 wherein the controller is configured to selectively switch wireless communications between the LMR and BB wireless communications networks based upon the respective communication costs.

5. The LMR device of claim 3 wherein the respective communications costs are based upon respective bandwidth availabilities associated with the LMR and BB wireless communications networks.

6. The LMR device of claim 3 wherein the respective communications costs are based upon respective signal-to-noise ratios associated with the LMR and BB wireless communications networks.

7. The LMR device of claim 1 wherein the controller is configured to operate a plurality of applications and selectively switch wireless communications between the LMR and BB wireless communications networks based upon a given one of the plurality of applications.

8. The LMR device of claim 1 wherein the wireless communications circuitry comprises one of WiFi communications circuitry and cellular communications circuitry operable over the BB wireless communications network.

9. The LMR device of claim 1 wherein the wireless communications circuitry comprises LMR circuitry operable over the LMR wireless communications network.

10. A communications system comprising:
a land mobile radio (LMR) wireless communications network;
a broadband (BB) wireless communications network; and
a land mobile radio (LMR) device comprising wireless communications circuitry selectively operable over the LMR wireless communications network and the BB wireless communications network, and
a controller cooperating with the wireless communications circuitry to wirelessly communicate via one of the LMR wireless communications network and the BB wireless communications network based upon a Locator ID Separation Protocol (LISP).

11. The communications system of claim 10 wherein the LISP uses Endpoint Identifiers (EIDs) and Routing Locators (RLOCs) based on a Mapping Database.

12. The communications system of claim 10 wherein the controller is configured to determine a respective communication cost associated with each of the LMR and BB wireless communications networks.

13. The communications system of claim 12 wherein the controller is configured to selectively switch wireless communications between the LMR and BB wireless communications networks based upon the respective communication costs.

14. The communications system of claim 12 wherein the respective communications costs are based upon at least one of respective bandwidth availabilities associated with the LMR and BB wireless communications networks and respective signal-to-noise ratios associated with the LMR and BB wireless communications networks.

15. The communications system of claim 10 wherein the wireless communications circuitry comprises one of WiFi communications circuitry and cellular communications circuitry operable over the BB wireless communications network.

16. The communications system of claim 10 wherein the wireless communications circuitry comprises LMR circuitry operable over the LMR wireless communications network.

17. A method of communicating using a land mobile radio (LMR) device, the method comprising:
operating a controller to cooperate with wireless communications circuitry selectively operable over an LMR wireless communications network and a broadband (BB) wireless communications network to wirelessly communicate via one of the LMR wireless communications network and the BB wireless communications network based upon a Locator ID Separation Protocol (LISP).

18. The method of claim 17 wherein the LISP uses Endpoint Identifiers (EIDs) and Routing Locators (RLOCs) based on a Mapping Database.

19. The method of claim 17 wherein operating the controller comprises operating the controller to determine a respective communication cost associated with each of the LMR and BB wireless communications networks.

20. The method of claim 19 wherein operating the controller comprises operating the controller to selectively switch wireless communications between the LMR and BB wireless communications networks based upon the respective communication costs.

21. The method of claim 19 wherein the respective communications costs are based upon at least one of a respective bandwidth availabilities associated with the LMR and BB wireless communications networks and respective signal-to-noise ratios associated with the LMR and BB wireless communications networks.

22. The method of claim 17 wherein operating the controller comprises operating the controller to selectively switch wireless communications between the LMR and BB wireless communications networks based upon a given one of a plurality of applications operated by the controller.
